(19) United States
(12) Patent Application Publication
(10) Pub. No.: US 2011/0187246 A1
(43) Pub. Date: Aug. 4, 2011

(54) Dish Washer

(76) Inventors: Gap Su Shin, Seoul (KR); Young Hyun Kim, Gyeongsangnam (KR)

(21) Appl. No.: 12/224,206

(22) PCT Filed: Feb. 22, 2007
(86) PCT No.: PCT/KR2007/000929

§ 371 Date: Aug. 21, 2008

(30) Foreign Application Priority Data
Feb. 22, 2006 (KR) 10-2006-0017263
Apr. 25, 2006 (KR) 10-2006-0037003

(51) Int. Cl. A47L 15/42; E05D 7/00; E05F 5/02

(52) U.S. Cl. 312/228; 16/223

(57) ABSTRACT

Dishwasher including a housing (1) having an opening in a front and a hinge shaft (43) for holding dishes to be washed therein, a door (2) rotatably mounted with the hinge shaft (43) for selective opening/closing of the opening in the housing (1), and a falling off preventive unit for preventing the door (2) from falling off the hinge shaft (43) in a case the door (2) rotates, thereby preventing the door (2) from falling off effectively in a case the door (2) is opened/closed.

### TECHNICAL FIELD

The present invention relates to dishwashers, and more particularly, to a dishwasher in which a hinge bracket structure is improved, for preventing a door thereof from falling off the dishwasher.

### BACKGROUND ART

In general, the dishwasher, which is very convenient home appliance for automatic washing and drying of dishes, has demand increased day by day.

FIG. 1 illustrates a structure of a related art dishwasher, provided with a washing tub 3 in a housing 1 which forms an exterior of the dishwasher, a washing pump 6 under the washing tub 3, a washing nozzle 5 on a bottom of the washing tub 3 connected to the washing pump 6, and a washing shelf 4 over the washing nozzle 5 of the washing tub 3 for holding dishes to be washed.

Mounted to a front of the housing 1, there is a door 2, and provided to an upper portion of the door 2 and an upper portion of the housing to be matched thereto, there is a door opening/closing device (not shown) for opening/closing the door 2.

The dishwasher washes contaminated dishes held on the washing shelf in the washing tub with washing water sprayed through the washing nozzle 5. The washing water has a certain amount of detergent introduced thereto, and may be heated to an appropriate temperature before being sprayed.

In the meantime, the door opening/closing device of the dishwasher serves both to seal the washing tub 3 under washing tightly for preventing the washing water from leaking, and sense whether the door 2 is opened or closed for preventing an accident caused by negligence of safety which can cause when the door 2 is opened in the middle of the washing.

In the meantime, a door opening/closing structure will be described with reference to FIG. 2 which is an enlarged view of ‘A’ part in FIG. 1.

Provided to a lower portion of the front of the housing (see FIG. 1), there is a hinge shaft 43 with which a hinge bracket 30 at a lower portion of the door 2 is rotatably engaged. That is, as shown, the hinge shaft 43 at the lower portion of the housing 1 is placed in a hinge slot 31 in an under side of the hinge bracket 30. This structure enables both the hinge bracket 30 and the door 2 to rotate around the hinge shaft 43.

However, the housing door of the related art dishwasher has the following problems.

The hinge slot in the hinge bracket at the lower portion of the door has an opened structure. Therefore, as shown in FIG. 2, in general cases, though the door does not breakaway from the housing owing to a weight of the door itself, when the door is opened/closed while the door is lifted up, it is liable that the hinge shaft is disengaged from the hinge slot in the hinge bracket while the door is lifted upward.

Moreover, in a case the door is disengaged from the hinge shaft, the door is liable to breakaway from the housing, and fall down to injure a user's foot.

### DISCLOSURE OF INVENTION

### Technical Problem

An object of the present invention devised to solve the problem lies on providing a dishwasher which can prevent the door thereof from breaking away during the door is opened/closed.

### Technical Solution

To achieve these objects and other advantages and in accordance with the purpose of the invention, as embodied and broadly described herein, a dishwasher includes a housing having an opening in a front and a hinge shaft for holding dishes to be washed therein, a door rotatably mounted with the hinge shaft for selective opening/closing of the opening in the housing, and a falling off preventive unit for preventing the door from falling off the hinge shaft in a case the door rotates.

The falling off preventive unit includes a hinge bracket provided to the door, the hinge bracket having a hinge slot formed therein for placing the hinge shaft therein, and a falling off preventive piece provided to the hinge slot for preventing the hinge shaft from falling off.

In detail, by bending toward an entrance to the hinge slot in a case the hinge shaft is placed in the hinge slot, the falling off preventive piece prevents the hinge shaft from falling off.

Moreover, the falling off preventive unit may include a hinge bracket provided to the door, the hinge bracket having a hinge slot for placing the hinge shaft, and a stopper at the hinge slot for preventing the hinge shaft from falling off.

The stopper is projected from the entrance to the hinge slot, moreover, the stopper is projected in a rounded shape, or the stopper is formed such that the stopper becomes the wider as it goes toward an outer side of the hinge slot the more.

In the meantime, the falling off preventive unit includes a hinge bracket provided to the door, the hinge bracket having a hinge slot formed therein, for placing the hinge shaft therein, wherein the hinge slot includes a placing in opening for placing in the hinge shaft therethrough, and a seating portion for seating the hinge shaft, wherein an inside circumference of the hinge slot that connects the placing in opening to the seating portion is bent at least once.

The hinge slot may further include a holding step for holding the hinge shaft to prevent the hinge shaft from falling off in a case the door is opened.

In the meantime, the dishwasher may further include a damping member provided to at least one of an inside circumference of the hinge slot and an outside circumference of the hinge shaft.

### Advantageous Effects

Refer to Industrial applicability at the end of the specification.

### BRIEF DESCRIPTION OF THE DRAWINGS

FIG. 1 illustrates a longitudinal section of a related art dishwasher, schematically.

FIG. 2 illustrates a section of key parts of a related art dishwasher showing falling off of a door during the door of a related art dishwasher is opened, schematically.

FIG. 3 illustrates a longitudinal section showing a hinge bracket provided to a door in a dishwasher in accordance with a first preferred embodiment of the present invention.

FIGS. 4 and 5 illustrate section's of key parts showing the steps of a process for mounting a door provided with the hinge bracket in FIG. 3.

FIG. 6 illustrates a section of key parts showing a lower portion of a hinge bracket provided to a door of a dishwasher in accordance with a second preferred embodiment of the present invention.

FIG. 7 illustrates a section of key parts showing a lower portion of a hinge bracket provided to a door of a dishwasher in accordance with a third preferred embodiment of the present invention.

FIG. 8 illustrates a longitudinal section showing a structure of a dishwasher in accordance with a fourth preferred embodiment of the present invention, schematically.

FIG. 9 illustrates a longitudinal section showing a state in which the door in FIG. 8 is rotatably engaged, schematically.

FIG. 10 illustrates a longitudinal section of the door in FIG. 9 in a rotated state.

### BEST MODE FOR CARRYING OUT THE INVENTION

Reference will now be made in detail to the preferred embodiments of the present invention, examples of which are illustrated in the accompanying drawings. Wherever possible, the same reference numbers will be used throughout the drawings to refer to the same or like parts.

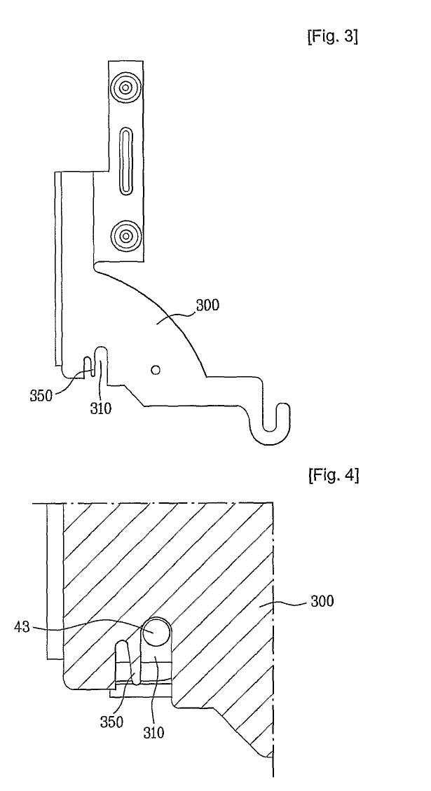

FIG. 3 illustrates a longitudinal section showing a hinge bracket provided to a door in a dishwasher in accordance with a first preferred embodiment of the present invention. Since parts of the dishwasher, such as the housing, the door, and the like other than the hinge bracket are similar to the related art dishwasher, detailed description of which will be omitted.

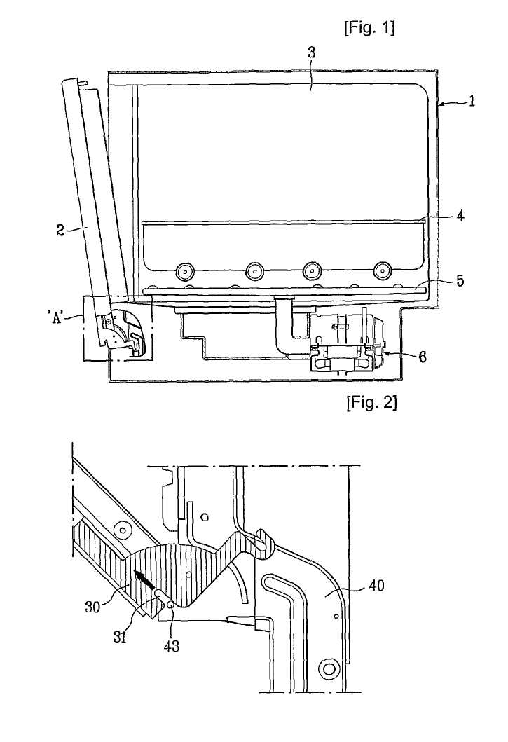

Referring to FIG. 3, the door 2 (see FIG. 1) has a hinge bracket 300 at a lower portion having a hinge slot 310 for placing a hinge shaft 43 on the housing 1 (see FIG. 1) therein. In the meantime, the present invention has a falling off preventive unit for preventing the hinge shaft 43 from falling off the hinge slot 310 in a case the door 2 rotates, which will be described in detail.

Referring to the hinge bracket 300 in FIG. 3, the hinge slot 310 has a falling off preventive piece 350 for preventing the hinge shaft 43 from falling off when the hinge bracket 300 having the hinge shaft 43 placed in the hinge slot 310 is rotated. That is, in the embodiment, the hinge bracket 300 having the hinge slot 310 formed therein and the falling off preventive piece 350 form the falling off preventive unit.

In the meantime, the falling off preventive piece 350 prevents the falling off of the hinge shaft 43 as the falling off preventive piece 350 is bent toward an entrance to the hinge slot 310 in a case the hinge shaft 43 is placed in the hinge slot 310.

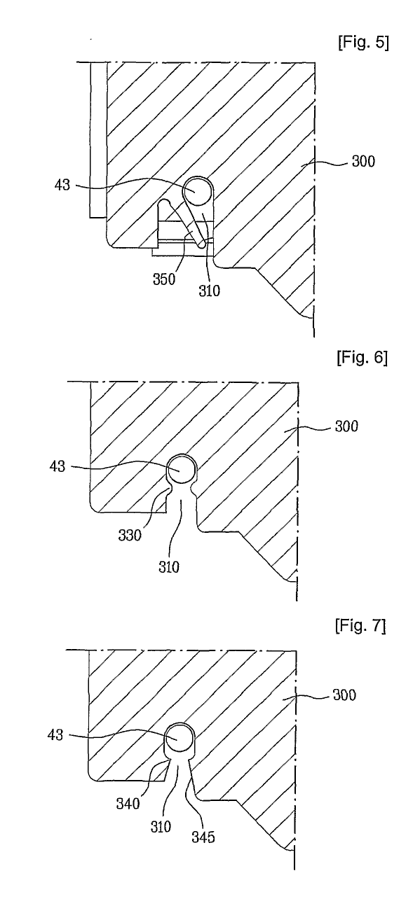

In detail, referring to FIG. 4, in the steps of a process for mounting the hinge bracket 300, by placing the hinge shaft 43 in the hinge slot 310, the hinge bracket 300 is mounted. Then, as shown in FIG. 5, the falling off preventive piece 350 is bent toward the entrance of the hinge slot 310, to close the entrance of the hinge slot 310 substantially. The substantial closure of the entrance of the hinge slot 310 with the falling off preventive piece bent thus enables to prevent the hinge shaft 43 from falling off the hinge slot 310 even airing the hinge bracket 300 rotates.

That is, if a structure as shown in FIG. 5 is made, during the door 2 is opened/closed, i.e., Wring the hinge bracket 300 is rotated around the hinge shaft 43, a structure is made with the falling off preventive piece 350, in which the hinge bracket 43 can not fall off the hinge slot 310, to make a structure in which the hinge bracket 300 can not fall off the hinge shaft 43. If a structure described above is made, since the hinge bracket 300 is fixedly secured to the lower portion of the door 2, safer and securer opening/closing of the door can be made.

FIG. 6 illustrates a section of key parts showing a lower portion of a hinge bracket provided to a door of a dishwasher in accordance with a second preferred embodiment of the present invention. In comparison to above embodiment, the embodiment has difference in a shape of the hinge slot in the hinge bracket. The embodiment will be described focused on the difference.

The hinge slot 310 of the hinge bracket 300 of the embodiment includes a stopper 330 for preventing the hinge shaft 43 from falling off during the door 2 (see FIG. 1) rotates. That is, in the embodiment, the hinge bracket 300 having the hinge slot 310 and the stopper 330 at the hinge slot 310 form a falling off preventive unit.

The stopper 330 is projected from the entrance to the hinge slot 310. As shown in FIG. 6, though the stopper 330 can be projected from one side of the hinge slot 310, it is preferable that the stopper 330 is projected from opposite sides of the hinge slot 310. The stopper may be convex with a rounded tip.

Referring to FIG. 6, the projection of the stopper 330 reduces the entrance to the hinge slot 310, to make removal of the hinge shaft 43 from the hinge slot 310 difficult once the hinge shaft 43 is placed in the hinge slot 310. Eventually, the falling off of the hinge shaft 43 from the hinge slot 310 can be prevented during the door is rotated.

In the meantime, FIG. 7 illustrates a section of key parts showing a lower portion of a hinge bracket provided to a door of a dishwasher in accordance with a third preferred embodiment of the present invention. In comparison to the embodiment of FIG. 6, the embodiment has difference in a shape of the stopper.

That is, in the embodiment, the stopper 340 may be projected such that the hinge slot 310 becomes the wider as it goes toward an outside of the hinge slot 310 the more, so as to be sloped such that a width of the hinge slot 310 becomes the narrower as it goes upward starting from a lower opening thereof. Moreover, as shown in FIG. 7, it is preferable that a slope 345 is formed at the lower opening of the hinge slot 310 having the stopper 340 formed for easy placing in action of the hinge shaft 430.

Referring to FIGS. 6 and 7, if the hinge shaft 43 is pushes into the hinge slot 310 having the stopper 330 or 340 with a predetermined external force, falling off of the hinge shaft 43 placed in the hinge slot 310 once is not easy owing to the stopper 330 or 340. That is, in this case too, when the door 2 is rotated, to rotate the hinge bracket 300 fixedly secured to the door 2, since the hinge shaft 43 held in the hinge slot 310 can not fall off the hinge slot 310, stable opening/closing of the door is made possible.

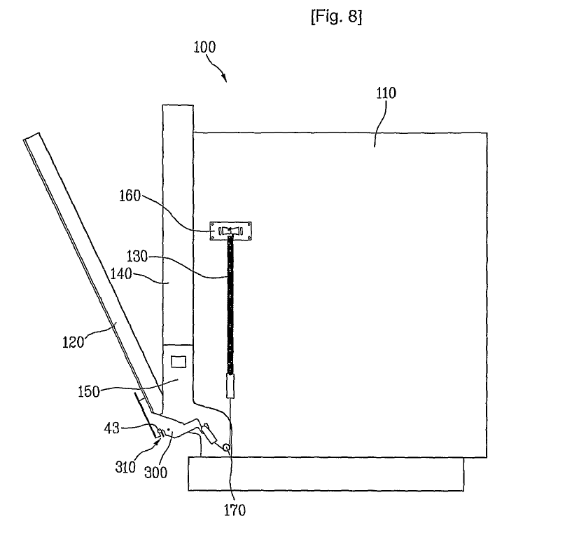

In the meantime, FIG. 8 illustrates a longitudinal section showing a structure of a dishwasher in accordance with a fourth preferred embodiment of the present invention, schematically.

Referring to FIG. 8, the dishwasher includes a frame 140 mounted to a front of the dishwasher, a door 120 mounted to a front of the frame, a supporter 150 fixedly secured to an underside of a side of the frame 140, a hinge bracket 300 fixedly secured to a lower portion of the door 120 and rotatably mounted to the supporter 150, a spring 130 connected to the hinge bracket 300, and a plate 160 for holding the spring 130.

The spring 130 has one end connected to a side of the housing 110, and the other end connected to the hinge bracket 300 so that the spring is extended by a predetermined distance when the door 120 is opened. In the meantime, the plate 160 is positioned at the end of the spring 130 for holding the one end of the spring 130. The supporter 150 fixedly secured to the underside of the frame 140 has a hinge shaft 43 for rotatable mounting of the hinge bracket 300 to a side of the frame 140. The hinge bracket 300 has a hinge slot 310 formed therein.

The steps of a process for opening/closing the door of the dishwasher will be described, briefly.

If the user pulls the door 120 forward to open the door 120, the hinge bracket 300 rotates in a counter clockwise direction by a predetermined angle around the hinge shaft 43.

Referring to FIG. 8, once the hinge bracket 300 rotates in the counter clockwise direction, a left side of the hinge bracket 300 moves down, while a right side thereof moves up. Since the right side at a fixed shaft 170 is connected to the other end of the spring 130, the spring 130 extends following the moving up of the right side. Accordingly, the door 120 stops at a point where an elastic force of the spring 130 generated according to a length of extension of the spring 130 and a load of the door 120 are substantially equal, preventing the door 120 from opening, fully.

Referring to FIG. 8, if the user pushes the door 120 forward while lifting up the door 120 upward for closing the door 120, the hinge bracket 300 rotates in a clockwise direction. Accordingly, the hinge bracket 300 rotates and returns to an original position, the spring 130 contacts as the right side of the hinge bracket 300 moves down, and the door 120 rotates to close the front of the tub.

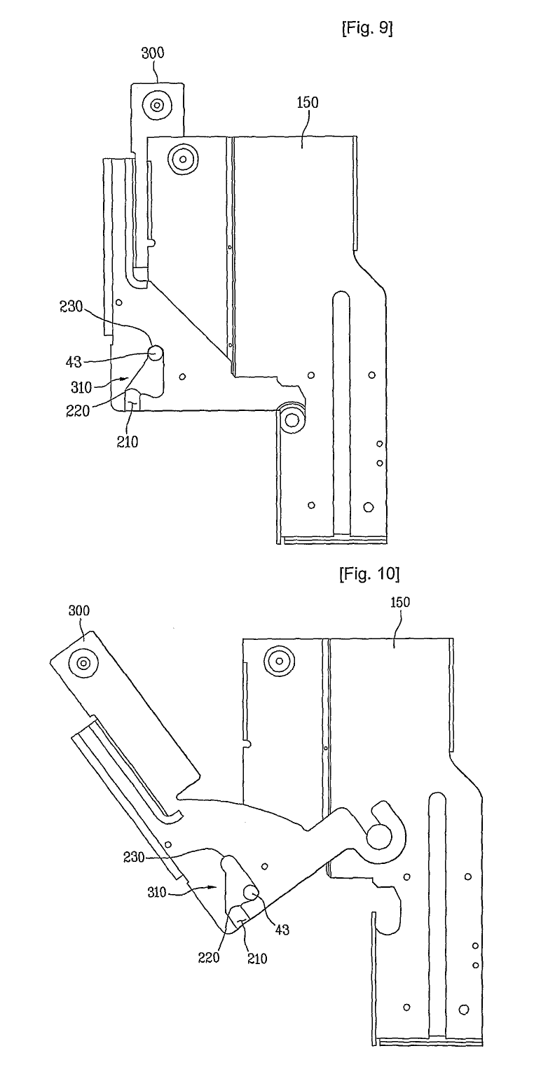

FIG. 9 illustrates a longitudinal section showing a state in which the hinge bracket at the lower portion of the door in FIG. 8 is rotatably engaged schematically, and FIG. 10 illustrates a longitudinal section of the door in FIG. 9 in a rotated state.

Referring to FIGS. 9 and 10, the hinge slot 310 in the hinge bracket 300 of the embodiment includes a placing in opening 210 for placing in the hinge shaft 43 therethrough, a seating portion 230 for seating the hinge shaft 43, and a holding step 220 for holding movement of the hinge shaft 43 following rotation of the hinge bracket 300.

The seating portion 230 is spaced a predetermined distance away from the placing in opening 210, and an inside circumference of the hinge slot 310 that connects the placing in opening 210 to the seating portion 230 is bent at least once. That is, the inside circumference of the hinge slot 310 has curve portions meanderingly bent a few times. Therefore, the hinge shaft 43 is placed in through the placing in opening 210 following a shape of the hinge slot 310, to seat at the seating portion 230, at the end.

In the meantime, the holding step 220 is formed so that the hinge shaft 43 does not fall off the hinge slot 310 in the hinge bracket 300 when the hinge shaft 43 moves a predetermined distance following rotation of the hinge bracket 300 in a case the user rotates the door.

In detail, the holding step 220, formed in a predetermined shape at a position where the hinge shaft 43 is to be held, holds the hinge shaft 43 when the user applies force to open the door. That is, the holding step 220 is formed at a portion the hinge shaft 43 is to be held, with a predetermined depth of recess. Moreover, in order to prevent the hinge shaft 43 from breaking away from the placing in opening 210 of the hinge slot 310, the holding step 220 has a tip projected upward further.

Preferably, the hinge slot 310 may have a damping member (not shown) having a predetermined elasticity placed therein for preventing the hinge shaft 43 from falling off the hinge slot 310. Though it is preferable that the damping member is formed of rubber, the material of the damping member is not limited to this.

The damping member has predetermined adherent force so that the hinge shaft 43 does not fall off the hinge slot 310 in a state the damping member is closely adherent to the hinge shaft 43. That is, the damping member covers at least one of an inside circumferential surface of the hinge slot 310 and an outside circumferential surface of the hinge shaft 43, to serve adherently.

A principle of the dishwasher having the hinge bracket 300 applied thereto will be described, briefly.

As described before, when the user pulls the door 120 forward to open the door, the hinge bracket 300 fixedly secured to the door 120 rotates in a counter clockwise direction by a predetermined angle. Together with the rotation of the hinge bracket 300, the spring 130 extends. In this instance, the hinge slot 310 in the hinge bracket 300 has the hinge shaft 43 of the supporter 150 placed therein.

Following the rotation of the hinge bracket 300, the hinge shaft 43 moves down to a portion where the holding step 220 in the hinge slot 310 is. In this instance, the falling off of the hinge shaft 43 from the placing in opening 210 is prevented by the holding step 220. That is, even if the user pulls the door 120, the holding step holds the hinge shaft 43.

Therefore, because the hinge shaft 43 is held by the holding step 220, the hinge shaft 43 does not fall off the hinge slot 310.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The dishwasher of the present invention has an advantage in that falling off of the door daring opening/closing of the door can be prevented by rotatably mounting the hinge shaft to the hinge bracket having the hinge slot formed therein.

Moreover, the dishwasher of the present invention has an advantage in that the easy mounting of the door owing to the hinge bracket at a final assembly process of the dishwasher permits a simple working process.

1. A dishwasher comprising:
a housing having an opening in a front and a hinge shaft for holding dishes to be washed therein;
a door rotatably mounted with the hinge shaft for selective opening/closing of the opening in the housing; and
a falling off preventive unit for preventing the door from falling off the hinge shaft in a case the door rotates.

2. The dishwasher as claimed in claim 1, wherein the falling off preventive unit inclines;
a hinge bracket provided to the door, the hinge bracket having a hinge slot formed therein for placing the hinge shaft therein, and
a falling off preventive piece provided to the hinge slot for preventing the hinge shaft from falling off.

3. The dishwasher as claimed in claim 2, wherein, by bending toward an entrance to the hinge slot in a case the hinge shaft is placed in the binge slot, the falling off preventive piece prevents the hinge shaft from falling off.

4. The dishwasher as claimed in claim 1, wherein the falling off preventive unit inclines;
a hinge bracket provided to the door, the hinge bracket having a hinge slot for placing the hinge shaft, and
a stopper at the hinge slot for preventing the hinge shaft from falling off.

5. The dishwasher as claimed in claim 4, wherein the stopper is projected from the entrance to the hinge slot.

6. The dishwasher as claimed in claim 5, wherein the stopper is projected at least one side of the entrance to the hinge slot.

7. The dishwasher as claimed in claim 5, wherein the stopper is projected in a rounded shape.

8. The dishwasher as claimed in claim 5, wherein the stopper is formed such that the stopper becomes the wider as it goes toward an outer side of the hinge slot the more.

9. The dishwasher as claimed in claim 1, wherein the falling off preventive unit inclines a hinge bracket provided to the door, the hinge bracket having a hinge slot formed therein, for placing the hinge shaft therein,
wherein the hinge slot includes;
a placing in opening for placing in the hinge shaft therethrough, and
a seating portion for seating the hinge shaft,
wherein an inside circumference of the hinge slot that connects the placing in opening to the seating portion is bent at least once.

10. The dishwasher as claimed in claim 9, wherein the hinge slot further includes a holding step for holding the hinge shaft to prevent the hinge shaft from falling off in a case the door is opened.

11. The dishwasher as claimed in claim 10, further comprising a damping member provided to at least one of an inside circumference of the hinge slot and an outside circumference of the hinge shaft.
